(19) United States
(12) Patent Application Publication
(10) Pub. No.: US 2002/0016857 A1
(43) Pub. Date: Feb. 7, 2002

(54) Address contact information retrieval, synchronization, and storage system

(76) Inventor: Adi Harari, Beverly Hills, CA (US)

Correspondence Address: CHRISTIE, PARKER & HALE, LLP, P.O. BOX 7068, PASADENA, CA, 91109-7068, US

(21) Appl. No.: 09/886,538

(22) Filed: Jun. 19, 2001

Related U.S. Application Data
(60) Provisional application No. 60/212,905, filed on Jun. 20, 2000.

(51) Int. Cl. G06F 15/173; G06F 15/16

(52) U.S. Cl. 709/238; 709/245

(57) ABSTRACT

An address server system. The address server system provides for automatic updates of user contact information by way of interaction with address clients.

### CROSS-REFERENCE TO RELATED APPLICATIONS

This application claims the benefit of the filing date of U.S. Provisional Application entitled Address Contact Information Retrieval, Synchronization, and Storage System (Application No. 60/212,905), the disclosure of which is hereby incorporated by reference herein.

### BACKGROUND OF THE INVENTION

The present invention relates generally to computer based address systems, and more specifically to a server based address system with automatic update capabilities.

Individuals, particularly those engaged in business, often have to keep track of phone numbers, addresses, etc. of numerous people. These people may be persons with whom an individual deals with on an often basis, persons the individual contacts occasionally, and persons the individual just recently met. For all of these people the individual is always faced with the challenge of maintaining up-to-date accurate information regarding how to contact and communicate with these other people. These other people, who are contacts of the individual, may change telephone numbers, addresses, or even positions or companies. In all of these instances the individual may wish to remain current with the person's information. In addition, the person who has changed particulars is often very desirous that other individuals be provided their updated information.

In the past, individuals often kept track of other individuals by way of maintaining, for example, business cards in a Roladex. Whenever a person in the Roladex moved it is up to the person who moved to provide the new contact information to all of their contacts. It was also required of each of the individual contacts to update their own address book. With the advent of computers for maintaining address information, this has often meant that as an individual moved they were required to inform all of their contacts of their new particulars, and each of their contacts was thereafter left to their own devices to update their computerized address books.

Such a system is undesirable for at least two reasons. First, as an individual changes particulars the individual is required to notify each and every one of his contacts of his new situation. This may not always be possible, particularly if someone the individual has given a business card to was unable to respond likewise, or for whom the individual may have lost some information. In addition, some individuals may have a huge number of contacts, and providing updated information to each and every one of those contacts may be such a gargantuan task that the contacts to receive updated information are culled from a superset of contacts. Further, such a system requires that each and every one of the contacts update their own address information. As it is the individual who changed particulars who knows the information best, it would be most desirable to have that individual update the contact information. Thus there is increased room for errors or for the failure to include appropriate information in such an updating system.

### SUMMARY OF THE INVENTION

The present invention therefore provides a server based address system including automatic update capabilities. In one embodiment the present invention comprises an address contact system to maintain a plurality of address contact information. The system comprises a plurality of address clients configured to respectively create a respective one of a plurality of address contact information. The system further comprises an address server coupled to the plurality of address clients in storing a plurality of address contact information, with the plurality of address clients configured to share address information by way of the address server.

These and other aspects of the present invention will be more fully understood when considered in connection with the following detailed description in conjunction with the accompanying drawings.

### BRIEF DESCRIPTION OF THE DRAWINGS

FIG. 1 illustrates an address contact system of the present invention;

FIG. 2 illustrates a flow diagram of a process of initial user registration for the system of FIG. 1;

FIG. 3 illustrates a structural data layout of an address contact information database;

FIG. 4 illustrates a display of an address contact list;

FIG. 5 illustrates a flow diagram of a process of an automatic update performed by an address server;

FIG. 6 illustrates a process of automatic address update performed by a client;

FIG. 7 illustrates a process of performing address distribution; and

FIGS. 8 and 9 illustrate alternative processes in accordance with aspects of the invention.

### DETAILED DESCRIPTION

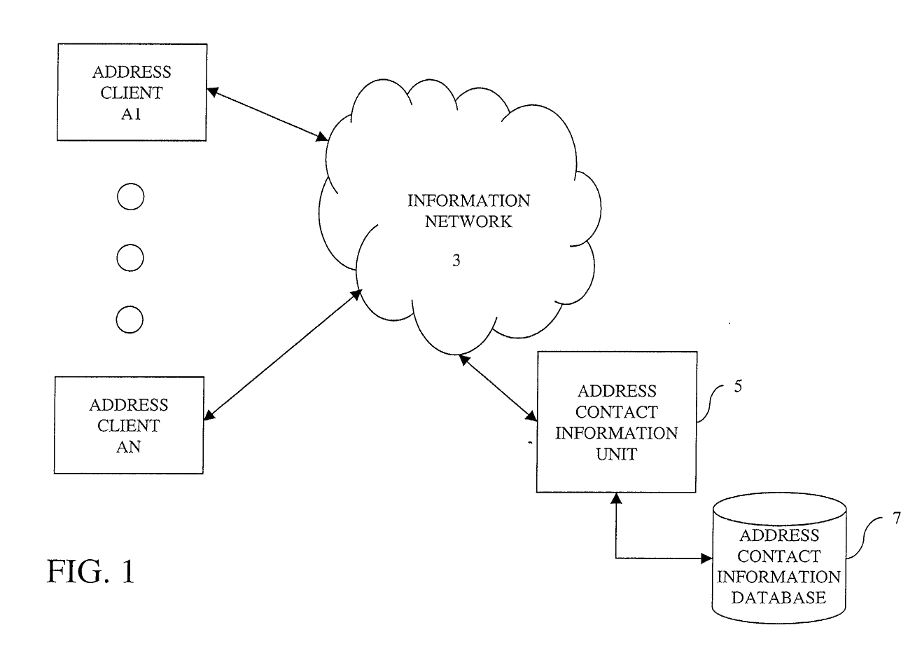

FIG. 1 illustrates one embodiment of the address contact system of the present invention. The address contact system includes multiple address user systems A1-AN. For clarity, first and a second address user systems A1 and AN are shown. However, the number of address user systems may be numerous and typically are geographically dispersed. Users, via the address user systems, are able to provide or supply their respective address contact information and view or receive address contact information about other users.

The address user systems A1-AN are coupled to an information network 3. The information network provides a common conduit for bi-directional communication between the address user systems A1-AN and an address information unit 5. In one specific embodiment, the information network 3 is a computer network that includes network devices such as routers, switches or repeaters, and integrated services digital network (ISDN) lines, digital subscriber lines (DSL), cable lines, and wireless connections such as radio frequency transmissions and satellite transmissions. The information network 3 is in various alternative embodiments, a computer network, such as a local area network (LAN), wide area network (WAN), the Internet, a television network or a conventional telephone system (POTS).

In one embodiment, the address user systems are a handheld computer, such as palm computers and the like, equipped with a modem to access the information network 3. Alternatively, a television equipped with a digital or analog set top box or a separate access terminal is used as the address client to connect to the information network 3. The separate access terminal includes cellular phones, wireless modems and other phone modems providing connection to the information network over a telephone network. In another embodiment, the address user system is a cellular or wireless telephone which communicates with a telephone network or cellular network to access the information network. The descriptions of the particular devices and accesses pertaining to the address user systems are exemplary and are not intended to be limiting in any sense.

Each user using address user systems A1-AN provides personal address contact information to the address information unit. The address information unit 5, coupled to the information network 3, stores the personal address contact information and uniquely associates each address contact information with the user providing the respective personal address contact information. The address information unit also manages additional address contact information provided by users using address user systems. In particular, the address information unit allows each user using an address user system to request access to some, none, or all of the address contact information stored by the address information unit. The address contact information unit also allows each user of an address user system to designate access by others to some, none, or all of the users stored personal address contact information.

In one embodiment, the address contact information unit 5 is coupled to a mass storage device 7. The mass storage device is a hard disk drive, a redundant array of independent disks (RAID) or a group of disks, also known as “just a bunch of disks” (JBOD). The mass storage device hosts at least one database, an address contact information database that contains information about address user systems A1-AN. In one embodiment, the address contact information database is hosted on an address contact database server. The database server maintains and organizes the address contact information database and provides connectivity between the address contact information unit and the address contact information database.

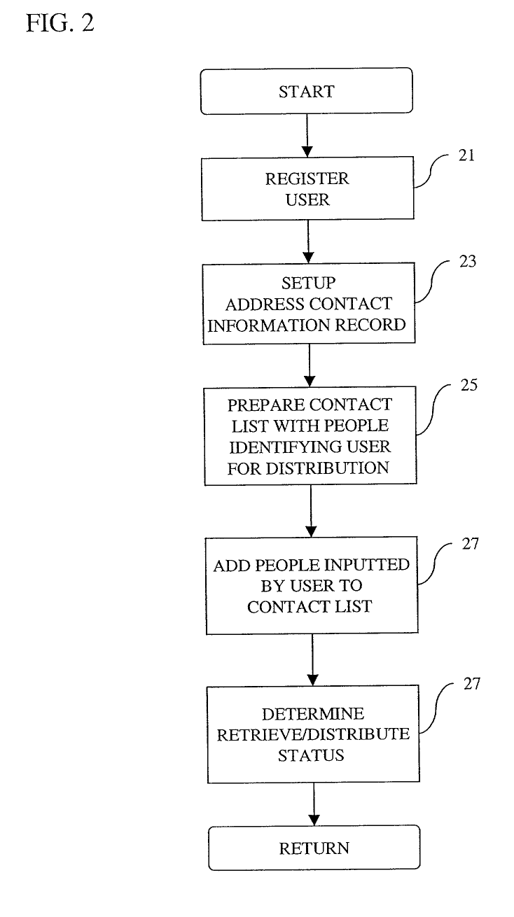

FIG. 2 illustrates a flow diagram of a process of initial user registration with a system in accordance with the present invention. As the address user systems often request information or services, for ease of further description the address user systems will be referred to as address clients. Further, as the address information unit generally serves as a server, and in one embodiment is a web server, the address information unit will be termed an address server. Thus, in block 21 of the process of FIG. 2 the address server provides an address client with a registration form. The registration form permits the user to register with the address server. The registration form includes input for a unique identification name or number and a password. The user, via the address client, also provides general contact information, e.g., full name, mailing address, telephone number, E-mail address and so on, to register the user. In block 23, the address server allows the user to provide an address contact information record pertaining to the user to the address server. The address contact information record includes, but is not limited to, files or links to files containing multimedia presentations. Thus, in one embodiment, the address information record is an electronic business card. For example, in the one embodiment, the address contact information record is a vCard. Details regarding vCard formats are available from the Internet Mail Consortium, Santa Cruz, Calif., and are also available on the Internet at www.imc.org.

The address contact information record is assigned an information ID by the address contact information unit. The information ID allows the address contact information unit to quickly identify and retrieve the associated address contact information record. The information ID is a unique number or key that points to the address contact information record. A date stamp is also attributed to the address contact information record. Initially, the date stamp designates a date and time upon the creation of the address contact information record. The date stamp is updated upon each update of the address contact information record.

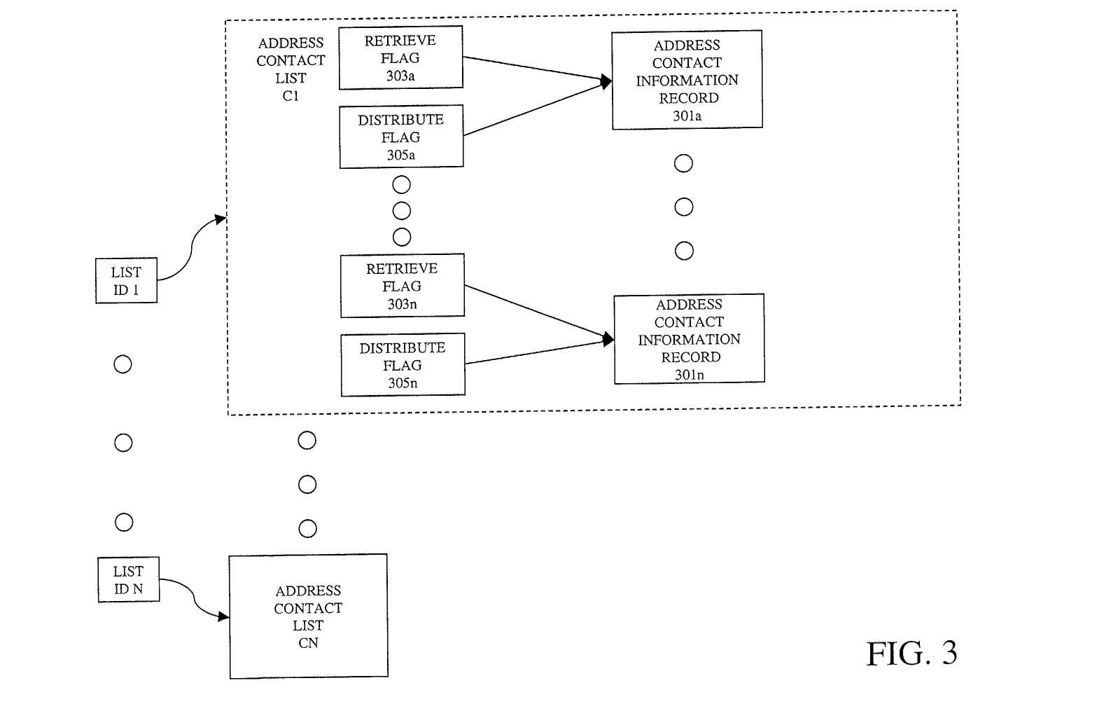

The address server also uses the address contact information record to determine if any other users have identified the user to receive automatic contact information updates. As is further described with respect to FIGS. 3-6, the address server provides for automatic updating of address contact information. This is accomplished if a first user indicates the desirability of distributing, or automatically updating, the records of another user, and the other user indicates the desirability of retrieving automatic updates from the first user. Potentially, some previously registered users may have indicated a desire to have a newly registered user receive automatic updates of information pertaining to the previous registered user. Accordingly, during initial registration, based on information in the address contact information record the address server determines if other registered users have indicated that they desire that the newly registered user receive automatic updates. If so, the address server includes those users in a contact list composed and provided to the address client in block 25 of the process of FIG. 2. The user thereafter adds additional contact information for other individuals as the user sees fit.

Associated with each individual in the contact list, whether provided by the address server or the user, are status flags. In particular, the status flags include a distribute flag and a retrieve flag. The distribute flag indicates the user desires to provide automatic updates of the user's user information record to the associated individual in the address contact list. The retrieve flag indicates the user desires to receive automatic updates of user information records from the associated individual in the address contact list. In the embodiment described, and also as discussed with respect to the other FIGs., users indicate on a form whether the distribute flag, the retrieve flag, or both should be set. The user provides information input on the form to the address server, for example by way of a POST command, which the address server responds to with execution of a common gateway interface (CGI) script, or program.

In block 27, the address server receives this information from the user. The address contact information unit also receives an indication of the retrieve/distribute status for each person on the contact list. As previously mentioned, if the retrieve status is set to true this indicates that the user desires to receive automatic updates of changes to the address information record from an identified contact. Similarly, if a particular contact is set to distribute, this means that the user desires that his own information be automatically distributed to that contact.

Referring now to FIG. 3, one embodiment of a structural data layout of the address contact information database is shown. The address contact information database includes address contact lists C1-CN. Each address contact list includes address contact information records associated to each address user system, as described in reference to FIG. 2, as well as status flags associated with each address contact information record.

Each list is also uniquely identified by a user/list ID 1-N. As such, each list user/ID 1-N is associated with a corresponding address contact list C1-CN. Also, each user/list ID 1-N is uniquely associated with a corresponding user of an address user system. Accordingly, when an address user system communicates with the address server, the address server identifies the user via the user/list ID. Upon identifying the user, the address server provides to the user the associated address contact list. For clarity, only one exploded view of an address contact list, list C1, is shown and described below.

The list C1 includes address contact information records 301a-301n. Associated or linked to each address information record is a retrieve flag and a distribute flag. For instance, retrieve flag 303a and distribute flag 305a are associated with address contact information contact record 301a. The retrieve and distribute flags are boolean in nature, e.g., providing a “true” or “false” conditional description. Thus, when the retrieve flag 303a is set to “true”, the user, e.g., a first user, has indicated that when the address contact information record 301a is updated, the first user is to be notified. As such, when the associated address information record is updated the address server provides changes or updated portions of the address contact information record for viewing by the first user. Conversely, when the retrieve flag 303a is set to “false”, the first user has indicated that when the address contact information record 301a is updated, the first user does not want to be notified.

When distribute flag 305a is set to “true”, the first user indicates that the first user wants to distribute updates of the address contact information record associated with the first user to another user, e.g., second user. The second user is the user that is associated with the address contact information record 301a. Conversely, when the distribute flag is set to “false”, the first user indicates that the first user does not want to distribute updates of the address contact information record associated with the first user to the second user. In other words, through the use of the retrieve flags, the first user is able to selectively indicate which address contact information record the first user is interested in viewing when the record is updated. However, through the use of the distribute flags, the first user is able to selectively indicate which other users (other than the first user) are to be sent the first user's address contact information record when the first user's record is updated.

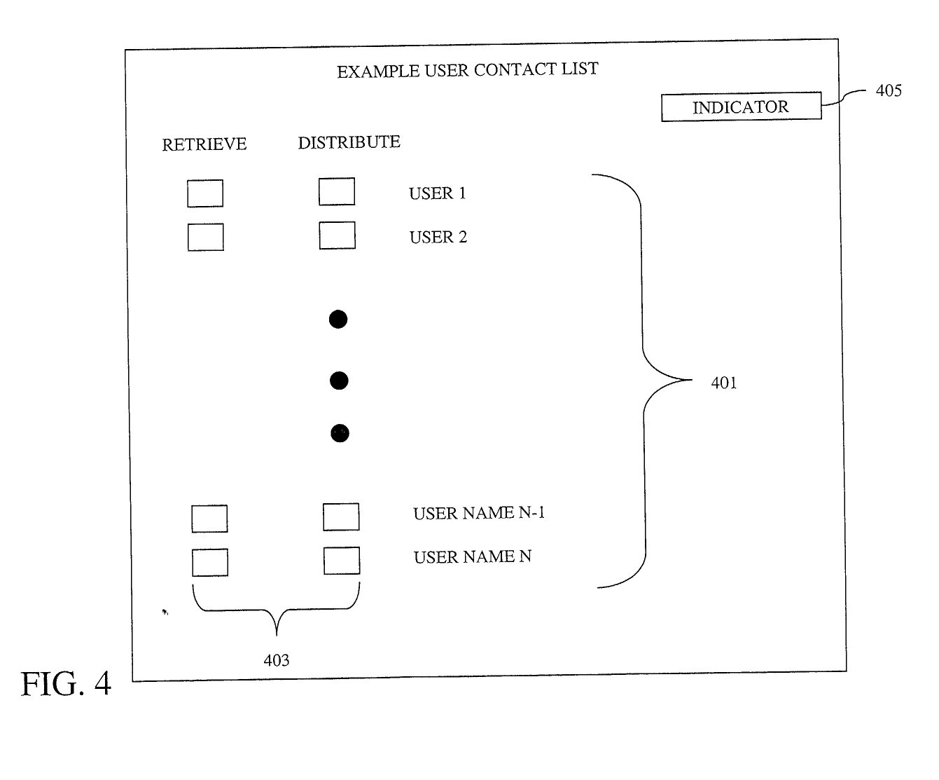

In FIG. 4, an exemplary display the address contact list for a user, example user, is illustrated. The exemplary display includes a list of names 401, e.g., John Smith, and other identifying user information, such as, a job title, a company name, an E-mail address, and so on. Each name listed corresponds to an address contact information record in the address contact list associated with example user. A pair of check boxes 403 is also included next to each name listed. One check box corresponds a retrieve flag and the other check box corresponds to a distribute flag. If a check box is checked, then the corresponding flag is set to “true”. Likewise, if a check box is not checked, then the corresponding flag is set to “false”. Also, included in the exemplary display is indicator box 405. The indicator icon signifies to example user whether an address contact information record in the address contact list has been updated. If the indicator icon is red, an address contact information record corresponding to one of the displayed list of names has been updated. If the indicator icon is green, none of the address contact information records corresponding to the displayed list of names has been updated.

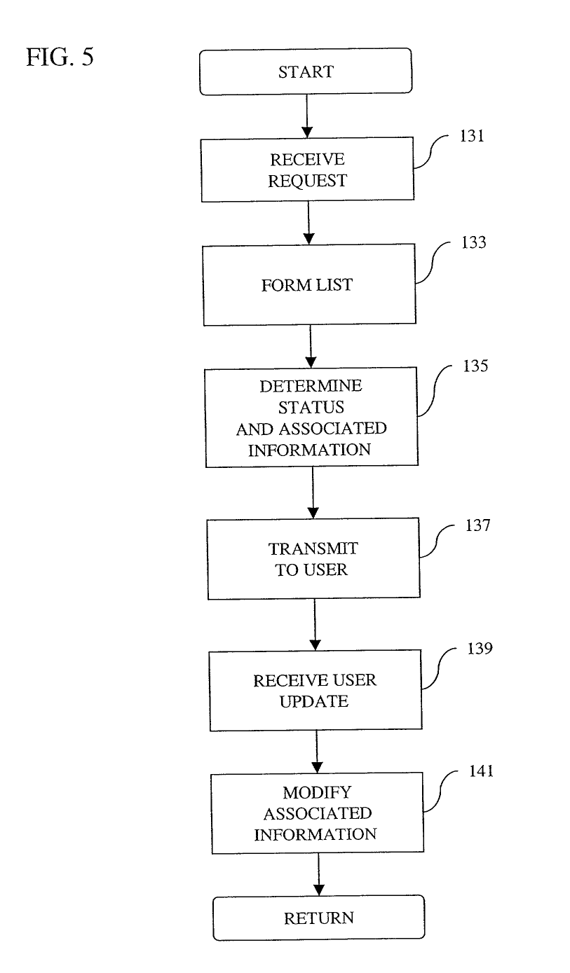

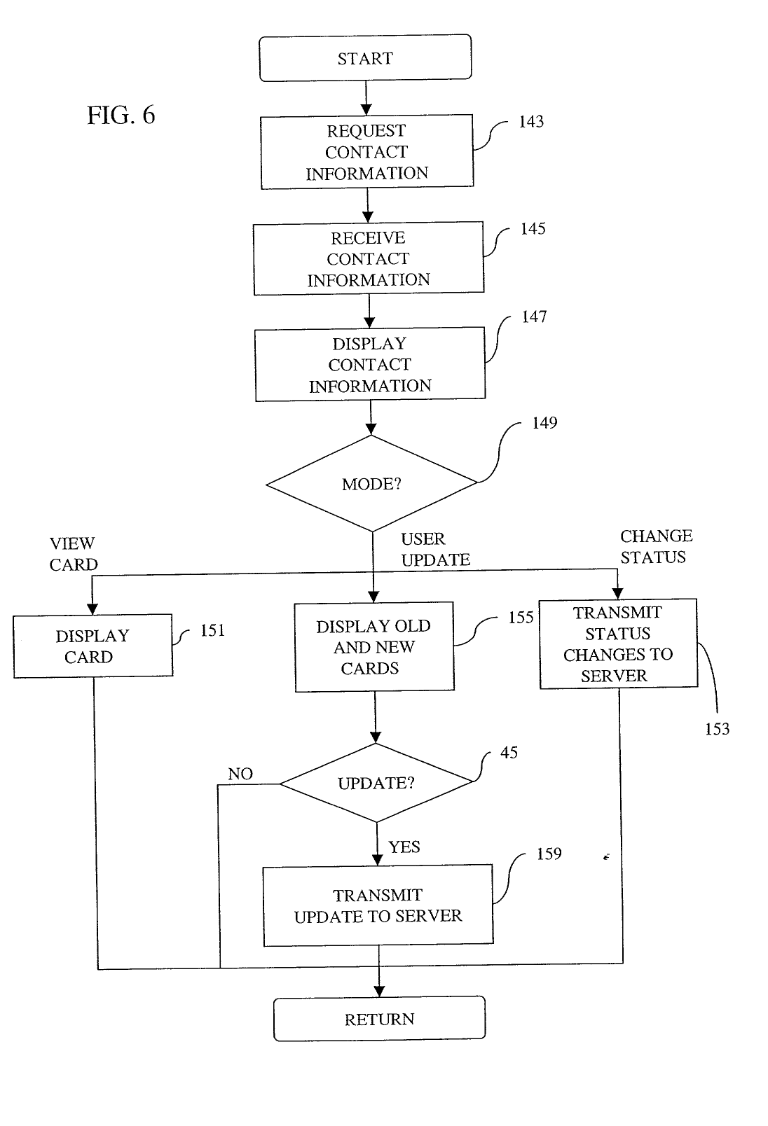

FIGS. 5 and 6 illustrate processes of performing automatic updates. FIG. 5 illustrates a flow diagram of a process of automatic update from the address server side. FIG. 6 illustrates a flow diagram of an update process on the client side. Generally speaking, the process includes an address client requesting contact information for a user using the address client from the server, and the server providing the contact information. The contact information includes a list of all persons on the user's contact list, Vcards for each of the contacts, and an indication of the status of the contacts. Indication of the status of the contacts includes whether the user has set them for retrieve and/or distribute, as well as whether the contact is in a synchronized or active state. In a synchronized state the contacts information is synchronized with the user's information. In the active state, the contact's information has been updated and the corresponding user information for that contact is not synchronized with that of the contact. Upon receipt of the contact information from the server, the client is able to display the vCards, update user information, and generally change the status of a contact.

Turning now to details of the server side process, in block 131 of FIG. 5 the address server receives a request for contact information. The request for contact information identifies a user requesting the contact information and the location of the user address system. In block 133 the address server forms a list including the user's contact list. The user's contact list includes all of the contacts for the particular user. The address server also, in block 135, determines the status of the individuals on the users contact list, as well as information associated with each individual on the users contact list. The status of the individuals on the users contact list include the state of the distribute flag, the state of the retrieve flag, and whether any of the associated information for individual contacts is in a synchronized or active state.

The determination of whether a contact is in a synchronized or active state is based on whether the user requesting the contact list has set the retrieve flag for a particular contact to true, and also whether the contact has also set their distribute flag for the particular user to true also. Accordingly, the address server examines the retrieve flags for each individual on the contact list. If the retrieve flag is set to retrieve for a particular contact, then the address server determines whether that particular contact is also a user of the system, and if so, if the particular contact has set a distribute flag for the user to distribute. If the contact has a distribute flag set to distribute for the user, and the user has set the retrieve flag to retrieve the contact's information, the address server determines if the update time for the associated information for the contact, in this embodiment the vCard, is of a more recent date than the associated information in the user's data. If so, the address server indicates that the associated information for the contact is active, namely in need of update. Otherwise, the address server indicates that the users information is synchronized with the contact's information.

In block 137 the address server transmits the contact list, status for each contact, and associated information to the address client. In one embodiment, this is accomplished by creating a web distributed data exchange (WDDX) javascript object for transmission of the status and associated information, as well as creation of a javascript file containing javascript functions for further operations.

After the user has updated the data in any way, as described with reference to FIG. 6, the address server receives the users update in block 139. In block 141 the address server then modifies records in the user's data. For example, and discussed more fully below, a user may wish to replace a contacts vCard with an updated vCard. In such a situation the user update provided to the address server indicates the identity of the contact, and details regarding the vCard. The address server will then, and the database in which user data is stored, will replace the contacts vCard in the users data with the updated vCard.

FIG. 6 illustrates a flow diagram of a client side process of automatically updating records. In block 143 a user using a user address system having an address client requests contact information for the user from the address server. The request for contact information identifies the user, as well as the location of the user address system. In block 145 the address client receives the contact information from the address server. In block 147 the address client causes the user's contact information to be displayed, for example, from a display terminal associated with the user address system. The display includes a list of the users contacts, the status of their retrieve and distribute flags, and an icon indicating whether those contacts for which the user may receive automatic updates are synchronized with any updated contact information.

In block 149 the address client determines a mode of operation. The modes of operation include viewing vCards, automatically updating vCard information, and changing retrieved and/or distribute flags associated with a contact. If the user elects to view a vCard in block 151 the address client causes the display associated with the user address system to display the vCard. The process thereafter returns. If, however, the user elects to change the status of a contact, the address client transmits the new status of the contact to the address server in block 153.

If the user elects to review an automated update of a contacts vCard, the address client causes the display associated with the user address system to display the vCard currently in the users system along side the more recent vCard modified by the contact in block 155. The concurrent display of the old and new vCards allows the user to determine if the user decides to allow the update of the users information. This allows the user, for example, to avoid replacing generally valid vCard information with vCard information that may have serious errors, such as being blank, or is otherwise obviously inaccurate or lacking information. In block 157 the address client determines if the user has elected to update the information. If the user has not elected to update the information the process returns. If the user has elected to update the information, then in block 159 the address client transmits a request to the address server to update the vCard information in the users data with the updated vCard. The process thereafter returns.

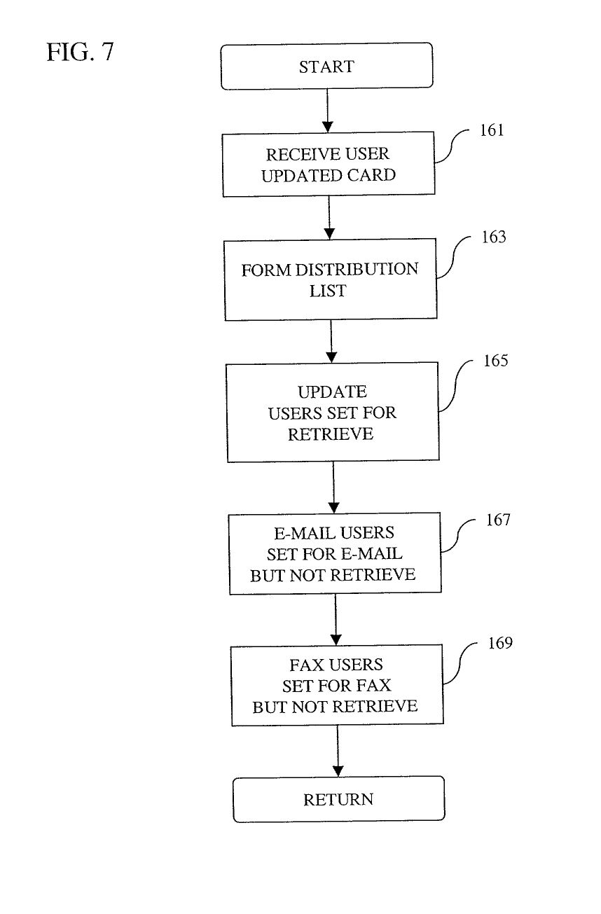

FIG. 7 illustrates a process of performing a vCard distribution when a user updates their personal vCard. In block 161 an address server receives an updated vCard for a particular user. In the event a user changes their vCard, the address server in block 163 forms a distribution list. The distribution list includes all contacts on the users contact list for whom the user has set the distribution flag to true. For each user on the distribution list who is the registered user of the address server, the address server determines if such users are set to retrieve updates from the particular user in block 165. This is accomplished by setting the state of the user and the contact list of the other users to an active state. The users information for those contacts is then updated as discussed with respect to FIGS. 5 and 6.

The user may also wish to distribute changes in his vCard to individuals not registered with the address server. Accordingly, in step 167 the address server provides an email to individuals on the contact list who have an email address, but are not set up for automatic distribution and retrieval of changes to the users vCard. Some contacts on the users contact list may not have an email address specified, however. For those individuals, the address server prepares a fax and faxes the new vCard to the individual's fax number, assuming one is listed in block 169. The process thereafter returns.

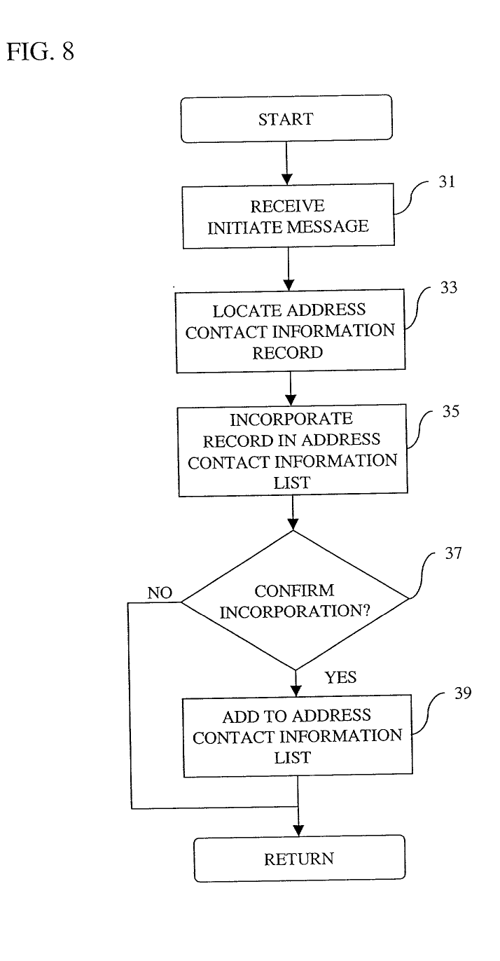

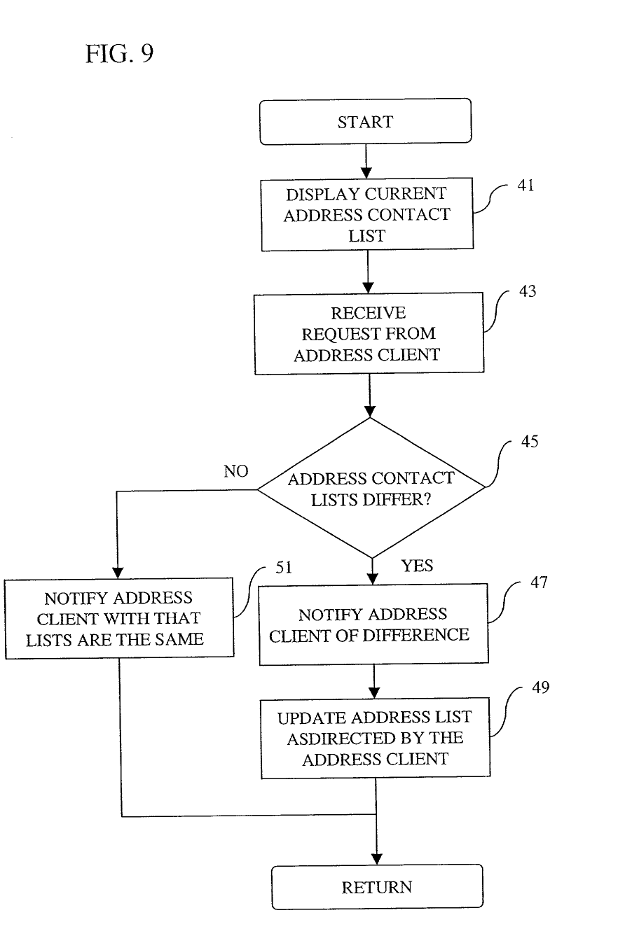

FIGS. 8 and 9 illustrate processes of alternative embodiments in accordance with aspects of the present invention. In FIG. 8, a process of linking the address clients to the address contact information unit is illustrated. In block 31, the address server receives an “initiate” message from an address client. For example, the “initiate” message includes a request from a first address client to add address contact information about a second address client into an address contact information list associated with the first address client. The address contact information unit then searches and locates the address contact information record pertaining to the second address client in block 33. In block 35, the address contact information unit incorporates the located address contact information record in the address contact information list of the first address client. In block 37, the address contact information unit confirms if the located address contact information is to be added to the address contact information list of the first address client. If the located address contact information is to be added, the address contact information unit adds the link id attributed to the located contact information to the address contact information list of the first address client in block 39. Otherwise, the process ends.

In FIG. 9, another embodiment of a process of linking the address clients to the address contact information unit is shown. In the described embodiment, the address contact information unit provides an address client a program to be executed by the address client. The program, in one embodiment, is an applet such as a javascript or another type of application specific software to be used in conjunction with a web browser or capable of emulating some of the functions of a web browser, executed by the address client. In block 41, the program displays a current address contact information list associated with the address client executing the program. In block 43, the program receives a request from the address client to determine if the current address contact information list displayed needs to be updated. The program in turn prepares and transmits a request to the address contact information unit for the most recent address contact information list associated with the address client.

The address contact information unit, upon receipt of the request from the address client, retrieves the most recent address contact information list associated with the address client that is stored, and transmits the list to the address client. In one embodiment, the address contact information unit initiates a database query to locate and retrieve the most recent address contact information list associated with the address client stored in the database. Once, the most recent address contact information list is located, the list is packaged for transmitting to the address client. For example, the list is prepared as a WDDX javascript object and transmitted to the address client.

In block 45, the address client determines if the transmitted most recent address contact information list is different from the current address contact information list. If the transmitted most recent address contact information list is different from the current address contact information list, then the program notifies the user of the address client of the difference in block 47. In one embodiment, the program notifies the user of the address client by displaying an icon to signify the differences. Furthermore, the program displays a side-by-side view highlighting the differences between the most recent address contact information list and the current address contact information list.

In block 49, the user, through the address client and thus the program, accepts or discards the differences. In other words, the current address contact information is updated or not updated with the differing information contained in the most recent address contact information list and the process ends.

If the transmitted most recent address contact information list is not different from the current address contact information list, the program, in block 51, notifies the user of the address client that the transmitted most recent address contact information list is the same as compared to the current address contact information list displayed and then the process ends.

Accordingly, the present invention provides a server address system. Although this invention has been described in certain specific embodiments, many additional modifications and variations would be apparent to those skilled in the art. It is therefore to be understood that this invention may be practiced otherwise than as specifically described. Thus, the present embodiments in the invention should be considered as illustrative and not restrictive, the scope of the invention to be indicated by the claims and their equivalents supported by this application rather than the foregoing description.

What is claimed is:

1. An address contact system to maintain a plurality of address contact information, the system comprising:
a plurality of address clients configured to respectively create a respective one of a plurality of address contact information;
an address server coupled to the plurality of address clients and storing the plurality of address contact information; and
wherein the plurality of address clients are configured to update the respective one of the plurality of address contact information and view the plurality of address contact information.

2. A method of maintaining a plurality of address contact information using an address contact system that includes a plurality of address clients and an address server, the method comprising:
creating one of a plurality of address contact information associated with one of a plurality of address clients;
storing the plurality of address contact information including the one of the plurality of address contact information;
updating the one of the plurality of address contact information by the one of the plurality of address clients; and
viewing the plurality of address contact information by the plurality of address clients.
